(19) United States
(12) Patent Application Publication
(10) Pub. No.: US 2010/0052230 A1
(43) Pub. Date: Mar. 4, 2010

(54) SPRING DEVICE CAPABLE OF STORING A WINDING FORCE

(75) Inventor: Paul Lin, Tainan Hsien (TW)

Correspondence Address: OSHA LIANG L.L.P., TWO HOUSTON CENTER, 909 FANNIN, SUITE 3500, HOUSTON, TX, 77010, US

(73) Assignee: MACAUTO INDUSTRIAL CO., LTD., Tainan Hsien (TW)

(21) Appl. No.: 12/198,760

(22) Filed: Aug. 26, 2008

(51) Int. Cl. F16F 1/06

(52) U.S. Cl. 267/155

(57) ABSTRACT

A spring device includes a tubular seat defining a shaft hole therethrough, a shaft, and a torsion spring. The shaft hole has a positioning hole section and a guiding section. The guiding section has a diameter smaller than that of the positioning hole section. The tubular seat further has a keyway that is in spatial communication with the guiding section of the shaft hole. The shaft has a shaft body and a key. The shaft body is extended through the shaft hole and is movable axially relative to the tubular seat between first and second axial positions. The shaft body is rotatable relative to the tubular seat when the shaft body is at the second axial position so as to accumulate a winding force in the torsion spring. The tubular seat further has a key stop that abuts against the key so that the key is offset from the keyway when the shaft body is at the first axial position.

### BACKGROUND OF THE INVENTION

1. Field of the Invention

The invention relates to a spring device, more particularly to a spring device capable of storing a winding force in order to perform a winding operation, e.g., winding a sunscreen on a vehicle sunshade assembly.

2. Description of the Related Art

As shown in FIG. 1, a conventional sunshade assembly 1 includes an elongate hollow base 11 to be disposed on an interior side of a vehicle window, a pair of end caps 12 respectively mounted on opposite ends of the base 11, a hollow roller unit 14 received in the base 11, a screen 15 connected to the roller unit 14, and a spring device 10 that stores a winding force for winding the screen 15 on the roller unit 14.

Referring to FIGS. 1 to 3, the spring device 10 includes a position unit 17 that is insertable into the roller unit 14, a shaft 18, and a torsion spring 19. The positioning unit 17 is formed with an axial hole 171, and has a pair of keyways 172 formed in a hole-defining surface of the positioning unit 17. The shaft 18 has a shaft body 181 extended through the axial hole 171 in the positioning unit 17, and a pair of keys 182 in sliding engagement with the keyways 172, respectively. The shaft body 181 has one end 183 inserted into the roller unit 14, and the other end 184 secured to one of the end caps 12. The torsion spring 19 is connected to the end 183 of the shaft body 181 at one end 191, and to the positioning unit 17 at the other end 192 thereof.

Prior to installing the spring device 10 into the roller unit 14, the shaft 18 is extended through the positioning unit 17 so that the keys 182 are disengaged from the keyways 172 (see FIG. 4). Then, through use of a torque-generating machine (not shown), the shaft 18 is rotated relative to the positioning unit 17 to accumulate a winding force in the torsion spring 19. Finally, the keys 182 are once again slid into the keyways 172 so as to prevent undesired rotation of the shaft 18 with respect to the positioning unit 17.

In use, the positioning unit 17 is coupled to the roller unit 14, and the end 14 of the shaft body 181 is coupled to one of the end caps 12. When the roller unit 14 is moved together with the positioning unit 17 relative to the shaft 18 to couple rotatably with the other end cap 12, the keys 182 are disengaged from the keyways 172, thereby resulting in rotation of the positioning unit 17 together with the roller unit 14 by virtue of the force previously accumulated in the torsion spring 19 so as to wind the screen 15 on the roller unit 14. Thereafter, when the screen 15 is extended from the roller unit 14, the torsion spring 19 is wound by virtue of rotation of the roller unit 14 together with the positioning unit 17 relative to the shaft 18.

Although engagement between the keys 182 and the keyways 172 can ensure storing of the winding force accumulated in the torsion spring 19 by preventing undesired rotation of the shaft 18 with respect to the positioning unit 17, such engaging mechanism is not completely fail-safe. That is, if the shaft 18 was moved axially relative to the positioning unit 17 by accident during installation or transport such that the keys 182 are disengaged from the keyways 172, the spring force in the torsion spring 19 will be undesirably released.

### SUMMARY OF THE INVENTION

Therefore, an object of the present invention is to provide a spring device that can overcome the above drawback of the prior art.

According to the present invention, a spring device includes a tubular seat that defines a shaft hole therethrough, a shaft, and a torsion spring. The shaft hole defines a hole axis and has a positioning hole section and a guiding section adjacent to the positioning hole section. The guiding section has a diameter smaller than that of the positioning hole section, and is defined by a hole-defining wall having a first end proximate to the positioning hole section and a second end opposite to the first end relative to the hole axis. The tubular seat further has a shoulder at the first end of the hole-defining wall, and a keyway that extends through the first and second ends of the hole-defining wall parallel to the hole axis and that is in spatial communication with the guiding section of the shaft hole. The shaft has a shaft body that defines a shaft axis, and a key that projects from the shaft body in a radial direction with respect to the shaft axis. The shaft body is extended through the shaft hole and is movable axially relative to the tubular seat between a first axial position, where the key is disposed in the positioning hole section to abut against the shoulder, and a second axial position, where the key is extended through the keyway and is disposed adjacent to the second end of the hole-defining wall. The torsion spring has one end connected to the shaft body and the other end connected to the tubular seat.

The shaft body is rotatable about the shaft axis relative to the tubular seat when the shaft body is at the second axial position so as to accumulate a winding force in the torsion spring. Additionally, the shaft body is movable from the second axial position back to the first axial position by extending the key through the keyway after accumulating the winding force in the torsion spring.

The tubular seat further has a key stop disposed in the positioning hole section. The key stop abuts against the key and is disposed to locate the key at an angular position offset from the keyway to prevent undesired movement of the shaft body from the first axial position to the second axial position after accumulating the winding force in the torsion spring.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional sunshade assembly, which has a spring device installed therein;

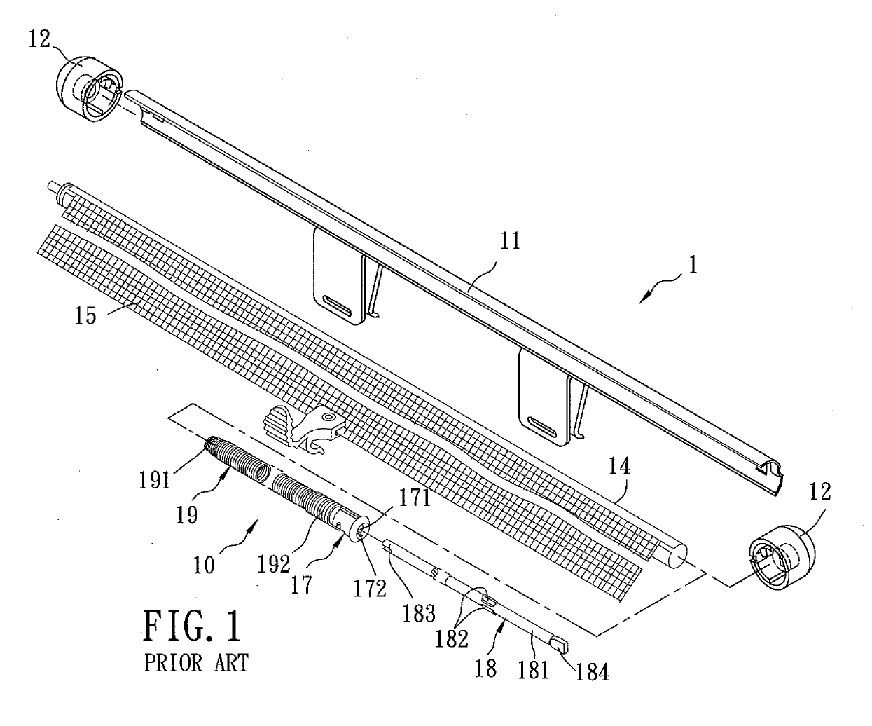

FIG. 2 is a partly sectional view of the spring device shown in FIG. 1, illustrating a pair of keys of a shaft engaging a pair of keyways of a positioning unit;

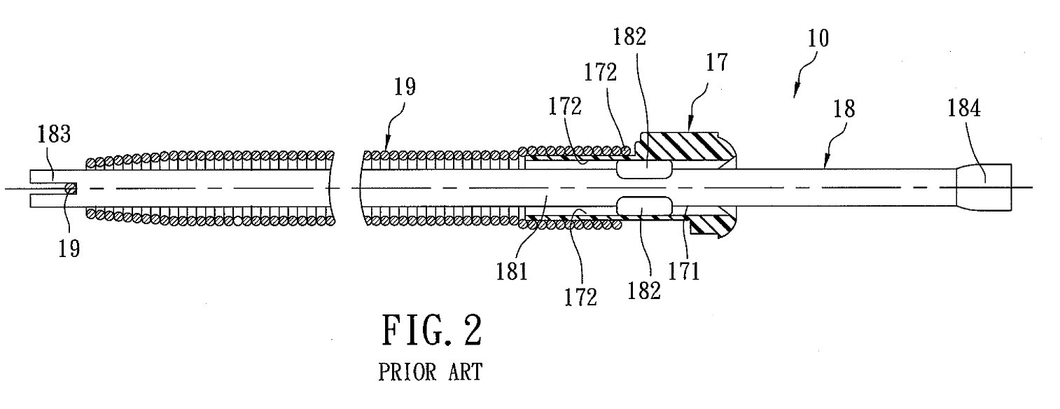

FIG. 3 is a radial cross-sectional view of the spring device shown in FIG. 2;

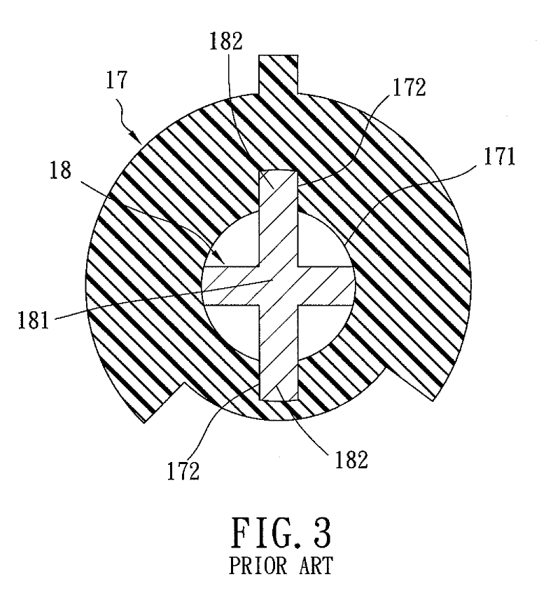

FIG. 4 is a view similar to FIG. 2, but illustrating the keys of the shaft when disengaged from the keyways of the positioning unit;

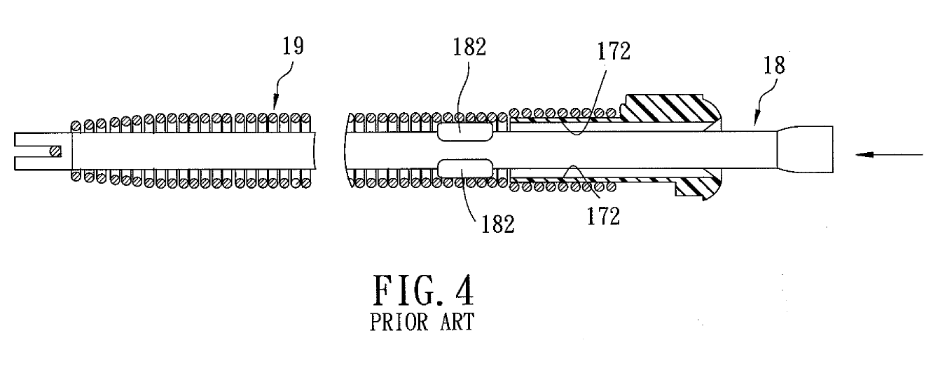

FIG. 5 is an exploded perspective view of the preferred embodiment of a spring device according to the present invention;

FIG. 6 is a partly sectional view of the preferred embodiment, illustrating a shaft body at a first axial position after accumulating a winding force in a torsion spring;

FIG. 7 is a radial cross-sectional view of the preferred embodiment, illustrating a state before the winding force is accumulated in the torsion spring;

FIG. 8 is a view similar to FIG. 6, but illustrating the shaft body at a second axial position; and

FIG. 9 is a view similar to FIG. 7, but illustrating a state after the winding force is accumulated in the torsion spring.

### DETAILED DESCRIPTION OF THE PREFERRED EMBODIMENT

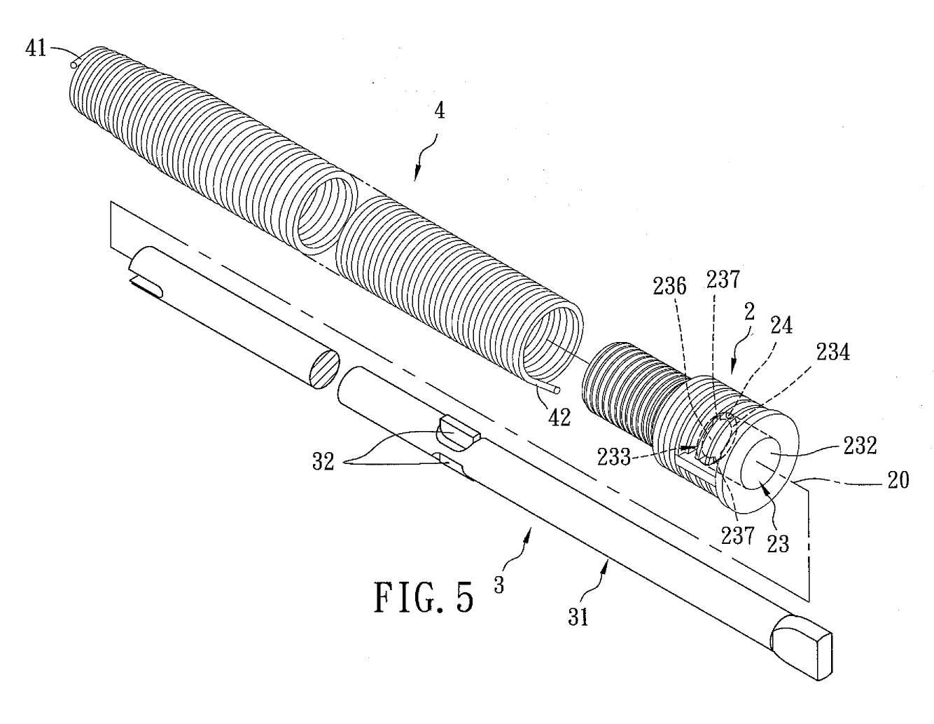

Referring to FIGS. 5 to 9, the preferred embodiment of a spring device according to the present invention is suitable for use in winding a screen on a roller unit in a vehicle sunshade assembly or an air filtration assembly. The spring device includes a tubular seat 2 defining a shaft hole 23 therethrough, a shaft 3, and a torsion spring 4. The shaft hole 23 defines a hole axis 20 and has a positioning hole section 232 and a guiding section 233 adjacent to the positioning hole section 232. The guiding section 233 has a diameter smaller than that of the positioning hole section 232, and is defined by a hole-defining wall 236 having a first end proximate to the positioning hole section 232 and a second end opposite to the first end relative to the hole axis 20. The tubular seat 2 further has a shoulder 234 at the first end of the hole-defining wall 23, and a pair of keyways 237 that extend through the first and second ends of the hole-defining wall 236 parallel to the hole axis 20 and that are in spatial communication with the guiding section 233 of the shaft hole 23. The shaft 3 has a shaft body 31 that defines a shaft axis, and a pair of keys 32 that project from the shaft body 31 in radial directions with respect to the shaft axis. The shaft hole 23 further has an extension hole section 231 adjacent to the second end of the hole-defining wall 236. The extension hole section 231 has a diameter larger than that of the guiding section 233. The shaft hole 23 further has a transition section 235 between the extension hole section 231 and the guiding section 233. The transition section 235 is defined by an inclined surface and is gradually reduced in diameter from the extension hole section 231 to the guiding section 233. In this embodiment, the torsion spring 4 has one end 41 connected to the shaft body 31 and the other end 42 connected to the tubular seat 2. The tubular seat 2 further has a key stop 24 disposed in the positioning hole section 232. In this embodiment, the key stop 24 projects from the shoulder 234 and is disposed adjacent to one of the keyways 237.

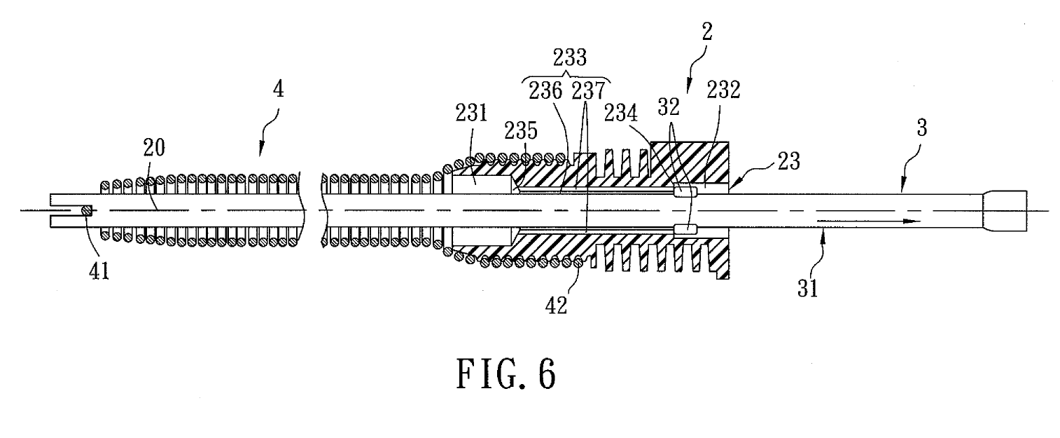

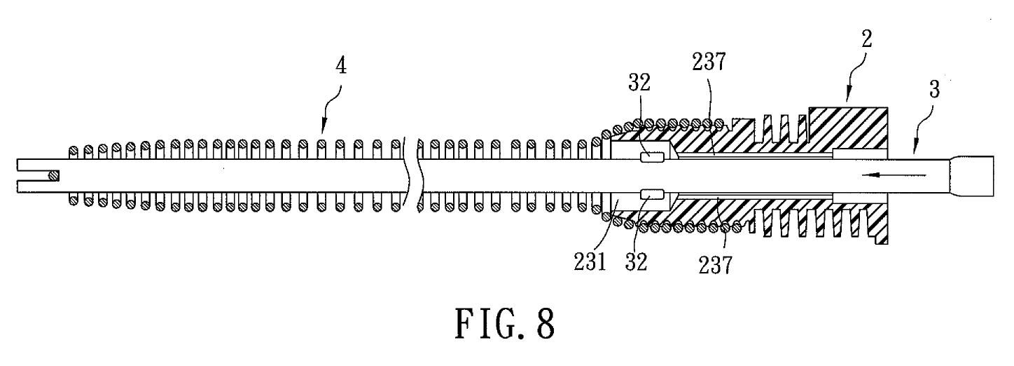

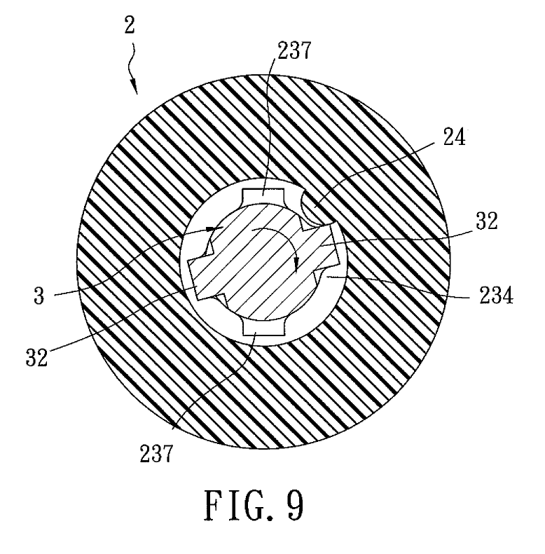

During assembly, the shaft body 31 is extended through the shaft hole 23 and is movable axially relative to the tubular seat 2 between a first axial position (see FIG. 6), where the keys 32 are disposed in the positioning hole section 232 to abut against the shoulder 234, and a second axial position (see FIG. 8), where the keys 32 are extended through the keyways 237 and are disposed adjacent to the second end of the hole-defining wall 236, i.e., in the extension hole section 231. Then, through use of a torque-generating machine (not shown), the shaft body 31 is rotated about the shaft axis relative to the tubular seat 2 when the shaft body 31 is at the second axial position (FIG. 8) so as to accumulate a winding force in the torsion spring 4. Subsequently, the shaft body 31 is moved from the second axial position back to the first axial position by extending the keys 32 through the keyways 237 after accumulating the winding force in the torsion spring 4. In the first axial position (see FIG. 9), the key stop 24 abuts against one of the keys 32 and is disposed to locate the keys 32 at an angular position offset from the keyways 237 to prevent undesired movement of the shaft body 31 from the first axial position to the second axial position and unwanted rotation of the shaft body 31 with respect to the tubular seat 2. In effect, the keys 32 are prevented from entering the keyways 237 undesirably and as a result, storage of the winding force in the torsion spring 4 can be ensured.

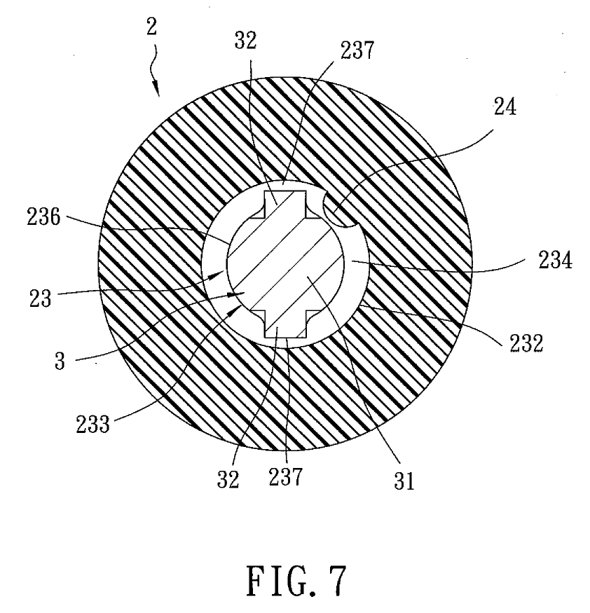

At any time when a user wants to unwind or release the spring force of the torsion spring 4, the user can simply exert a slight force on the shaft 3 to register the keys 32 with the keyways 237 (see FIG. 7) and then move the shaft body 31 from the first axial position to the second axial position.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A spring device comprising:
a tubular seat defining a shaft hole therethrough, said shaft hole defining a hole axis and having a positioning hole section and a guiding section adjacent to said positioning hole section, said guiding section having a diameter smaller than that of said positioning hole section, and being defined by a hole-defining wall having a first end proximate to said positioning hole section and a second end opposite to said first end relative to said hole axis, said tubular seat further having a shoulder at said first end of said hole-defining wall and a keyway that extends through said first and second ends of said hole-defining wall parallel to the hole axis and that is in spatial communication with said guiding section of said shaft hole;
a shaft having a shaft body that defines a shaft axis, and a key that projects from said shaft body in a radial direction with respect to said shaft axis;
said shaft body being extended through said shaft hole and being movable axially relative to said tubular seat between a first axial position, where said key is disposed in said positioning hole section to abut against said shoulder, and a second axial position, where said key is extended through said keyway and is disposed adjacent to said second end of said hole-defining wall; and
a torsion spring having one end connected to said shaft body and the other end connected to said tubular seat;
said shaft body being rotatable about said shaft axis relative to said tubular seat when said shaft body is at the second axial position so as to accumulate a winding force in said torsion spring;
said shaft body being movable from the second axial position back to the first axial position by extending said key through said keyway after accumulating the winding force in said torsion spring;
said tubular seat further having a key stop disposed in said positioning hole section, said key stop abutting against said key and being disposed to locate said key at an angular position offset from said keyway to prevent undesired movement of said shaft body from the first axial position to the second axial position after accumulating the winding force in said torsion spring.

2. The spring device as claimed in claim 1, wherein said shaft hole further has an extension hole section adjacent to said second end of said hole-defining wall, said extension hole section having a diameter larger than that of said guiding section, said shaft hole further having a transition section between said extension hole section and said guiding section, said transition section being defined by an inclined surface and being gradually reduced in diameter from said extension hole section to said guiding section.
